(19) United States
(12) Patent Application Publication
(10) Pub. No.: US 2003/0076057 A1
(43) Pub. Date: Apr. 24, 2003

(54) Device for illumination or signaling with light-emitting diodes

(76) Inventor: Benoist Fleury, Bobigny Cedex (FR)

Correspondence Address: MORGAN & FINNEGAN, L.L.P., 345 Park Avenue, New York, NY, 10154-0053, US

(21) Appl. No.: 10/274,013

(22) Filed: Oct. 18, 2002

(30) Foreign Application Priority Data
Oct. 19, 2001 (FR) 0113552

(51) Int. Cl. H05B 41/16

(52) U.S. Cl. 315/291; 315/247

(57) ABSTRACT

The present invention relates to a device for illumination or signaling, comprising at least two light-emitting diodes that each emit a light beam and are supplied with a pulsed current so as to be lit alternately, the pulses of the supply current of the light-emitting diodes having an instantaneous intensity higher than the maximum intensity in steady state and an average intensity lower than this maximum value, the pulses of the supply current of the light-emitting diodes having a duty ratio greater than or equal to the inverse of the number of light-emitting diodes.

According to the present invention, it comprises an optical system that receives the light beams emitted by the light-emitting diodes and delivers a single emergent beam, irrespective of which light-emitting diode is providing it with an incident beam.

### FIELD OF THE INVENTION

The present invention relates to devices for illumination or signaling, whose light sources consist of light-emitting diodes. Such light sources are customarily combined with optical systems for forming an illumination or signaling light beam having predetermined photometric and geometrical characteristics.

### BACKGROUND OF THE INVENTION

The use of light-emitting diodes makes it possible to profit from their small size in order to produce relatively compact illumination or signaling devices. Furthermore, the low level of heat dissipation caused by the operation of light-emitting diodes makes it possible, for example, to use plastics in their immediate vicinity, while, under the same conditions, incandescent or halogen lamps would demand the use of materials capable of withstanding high temperatures. This therefore results in reduced size and cost.

The use of a plurality of light-emitting diodes also makes it possible to increase the light flux of illumination or signaling devices when these light-emitting diodes are lit simultaneously, as represented in FIG. 1. It can be seen in this Figure that the light-emitting diodes 1 and 2 each deliver a flux Φ₁ and Φ₂, respectively, these fluxes being added together to give a resultant flux (Φ₁+Φ₂) in the common part resulting from superposition of the light beams Φ₁ and Φ₂ emitted by the light-emitting diodes 1 and 2.

In spite of current progress, the luminance of a light-emitting diode is still much less than that of a conventional incandescent, halogen or discharge light source. The luminance of a light source denotes the luminous intensity which it emits divided by its apparent surface area,

$$L = \frac{I}{S} ,$$

i.e. I=L*S, the luminous intensity being itself defined as the quantity of light emitted by the light source in a given direction.

In order for the luminous intensity delivered by a source to be increased up to a predetermined value, it is therefore necessary to increase the luminance of this source and/or its apparent surface area. These two parameters are very difficult to address or modify for light-emitting diodes. This is because, for a light-emitting diode with an emissive surface area dictated by design, it is not possible to increase its luminance by using optical means.

The present invention falls within this context and its object is to propose a device for illumination or signaling that uses a plurality of light-emitting diodes as light sources in order to form a light beam of predetermined intensity, while increasing the luminance of each light-emitting diode.

The present invention therefore relates to a device for illumination or signaling, comprising at least two light-emitting diodes that each emit a light beam and are supplied with a pulsed current so as to be lit alternately, the pulses of the supply current of the light-emitting diodes having an instantaneous intensity higher than the maximum intensity in steady state and an average intensity lower than this maximum value, the pulses of the supply current of the light-emitting diodes having a duty ratio greater than or equal to the inverse of the number of light-emitting diodes.

### SUMMARY OF THE INVENTION

According to the present invention, the device comprises an optical system that receives the light beams emitted by the light-emitting diodes and delivers a single emergent beam, irrespective of which light-emitting diode is providing it with an incident beam.

According to other advantageous and nonlimiting characteristics of the invention:

the light-emitting diodes are arranged on a mobile support which can be displaced in front of the optical system, the light-emitting diodes being lit synchronously with their entry into a predetermined position with respect to the optical system;

the mobile support is a wheel or a drum;

the light beams emitted by the various light-emitting diodes are switched so that the beam incident on the optical system is always the same, irrespective of which light-emitting diode is lit;

the light beams emitted by the various light-emitting diodes are switched by mechanical means synchronized with the lighting and extinguishing of the light-emitting diodes;

the mechanical means are mobile mirrors;

the light beams emitted by the various light-emitting diodes are switched by electro-optical means synchronized with the lighting and extinguishing of the light-emitting diodes;

the electro-optical means consist of electro-optical cells;

the electro-optical means consist of micromirrors.

Other objects, characteristics and advantages of the present invention will be made clear from the description, which will now be given, of an exemplary embodiment provided without implying any limitation and with reference to the appended drawings, in which:

### BRIEF DESCRIPTION OF THE DRAWINGS

FIG. 1 represents the light beams emitted by two adjacent light-emitting diodes,

FIGS. 2A and 2B represent, on graphs, the intensity of the supply current of a light-emitting diode according to the present invention,

FIGS. 3A and 3B schematically represent the principle of the present invention,

FIG. 4 schematically represents a first embodiment of the present invention,

FIGS. 5A and 5B schematically represent a second embodiment of the present invention,

FIGS. 6A and 6B schematically represent a third embodiment of the present invention, and

FIGS. 7A and 7B schematically represent a fourth embodiment of the present invention.

### DESCRIPTION OF THE PREFERRED EMBODIMENTS

In the various figures, elements that are identical or fulfill the same role are allocated the same reference symbols.

It is known that a light-emitting diode is designed and dimensioned in order to operate by being lit with a direct current lower than or equal to a current of maximum intensity in steady state Iₘₐₓ, which is predetermined so as to produce a predetermined maximum light flux Φₘₐₓ corresponding to a predetermined maximum luminance Lₘₐₓ.

For any variation of the direct current of intensity I_{low} lower than Iₘₐₓ, the flux Φ and the luminance L of the light-emitting diode vary substantially proportionally with the intensity I_{low}.

If the light-emitting diode is supplied with a current of intensity I_{high} higher than the intensity Iₘₐₓ, the flux Φ and the luminance L of the light-emitting diode increase beyond Φₘₐₓ and Lₘₐₓ, respectively, but the intensity of the current flowing through the light-emitting diode also increases. The result of this is a rise in the temperature of its junction owing to the Joule effect, which weakens the light-emitting diode, shortens its life and may even destroy it if the temperature of the junction exceeds a limit value Tⱼ, referred to as the junction temperature, at which the junction melts and the light-emitting diode is destroyed.

The above considerations apply to a steady state of the intensity I_{high}. It is, however, possible to supply the light-emitting diode with a current of instantaneous intensity Iₚ higher than the maximum intensity in steady state Iₘₐₓ, if this supply does not cause a temperature rise of the junction of the light-emitting diode.

Such is the case, for example, with a supply by pulses or by pulse trains as represented in FIGS. 2A and 2B. These figures show the shape of a current consisting of pulses, whose instantaneous value Iₚ is higher than the maximum value in steady state Iₘₐₓ of the intensity, but whose average value I_{average} is lower than this maximum value.

Under these conditions, during the pulses of instantaneous intensity Iₚ, it is observed that the flux Φ and the luminance L of the light-emitting diode vary substantially proportionally with the value of this intensity Iₚ. It is therefore possible to increase the luminance L of a light-emitting diode temporarily beyond the maximum value Lₘₐₓ, without thereby compromising its correct operation or its life. This is because the light-emitting diode, when “seeing” only a current of intensity I_{average} lower than the maximum intensity in steady state Iₘₐₓ, will not experience any heating which could be detrimental to it.

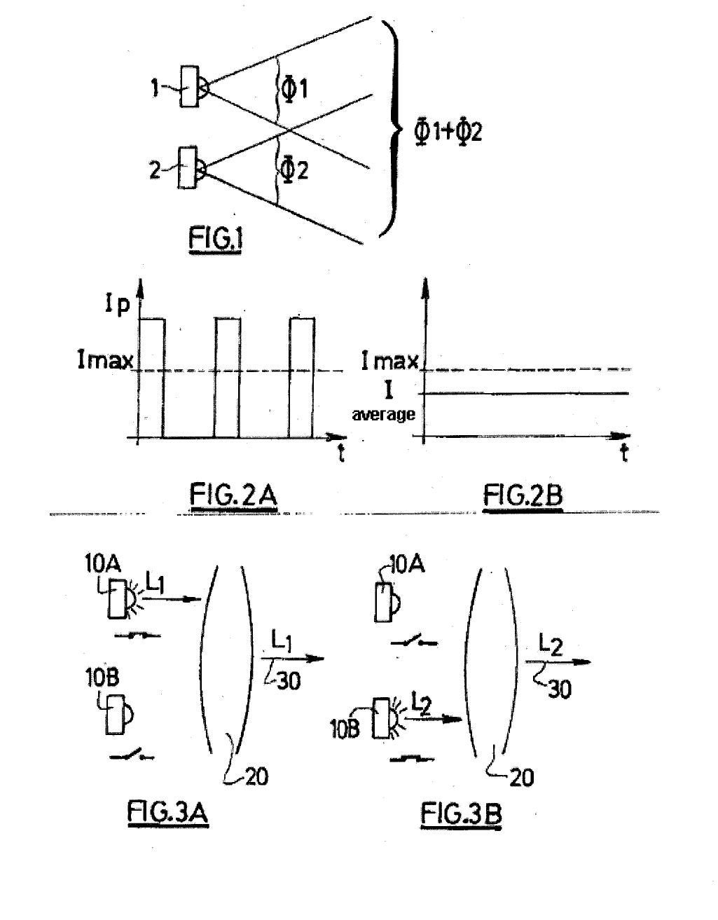

It is hence possible to produce a device for illumination or signaling, whose light sources are light-emitting diodes with enhanced luminance, the light-emitting diodes being supplied with a pulsed current of given duty ratio, that is to say the ratio of the duration of a pulse to the duration of a period, the number of light-emitting diodes being at least equal to the inverse of this duty ratio, so that there is always at least one light-emitting diode which is lit. This is what is shown schematically in FIGS. 3A and 3B, while representing only two light-emitting diodes 10A and 10B for clarity of the drawing, and while assuming that the duty ratio of their supply is equal to 1/2. When the light-emitting diode 10A is lit, the light-emitting diode 10B is extinguished, and vice versa. The light beam emitted by these light-emitting diodes is received by an optical system 20, which delivers a single emergent beam 30, irrespective of which light-emitting diode is providing it with an incident beam.

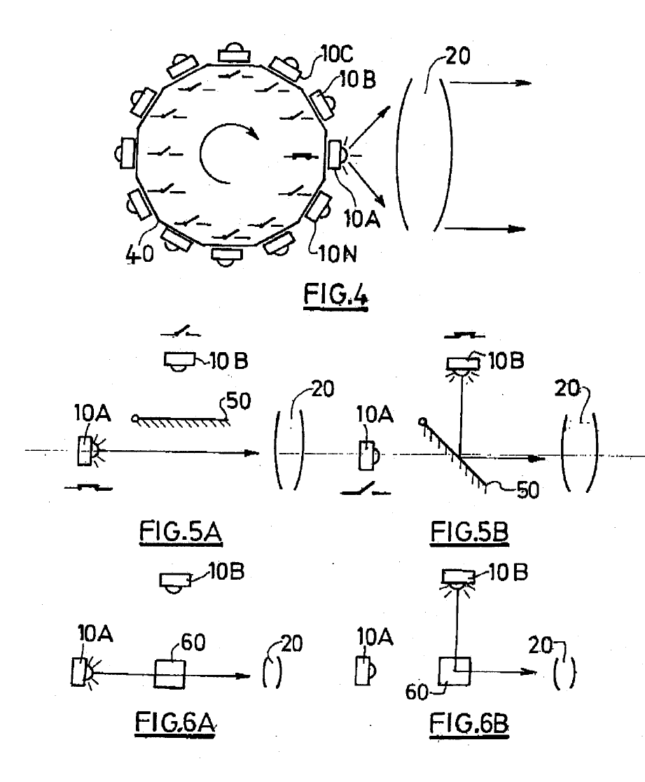

Various possibilities are then available in order to obtain such a result. For example, as represented in FIG. 4, the light-emitting diodes may be arranged on a mobile support, and this support may be displaced by means of a mechanical system so that a lit light-emitting diode is always arranged at the input of the optical system 20, the other light-emitting diodes being extinguished.

For example, the light-emitting diodes 10A, 10B, . . . 10N may be placed on a wheel or a drum 40, and their lighting may be synchronized with their entry into a predetermined position with respect to the optical system 20. For example, a drive movement of the wheel or drum 40 could be provided by using a Maltese cross system, so that each light-emitting diode remains at the input of the optical system 20 during the time it is lit, the transition from one light-emitting diode to another being carried out in a much shorter time. Such drive systems are used, for example, in cinematographic projectors in order to drive the film.

The light-emitting diodes may also be arranged fixed with respect to the optical system 20, and the light beams emitted by the various lit light-emitting diodes may be switched so that the beam incident on the optical system 20 is always the same, irrespective of which light-emitting diode is lit.

Mechanical means could be used, for example, as represented in FIGS. 5A and 5B, with mirrors 50 being mobile in rotation between two positions, for example, and synchronized with the lighting and extinguishing of the light-emitting diodes 10A and 10B so that the light beam at the input of the optical system 20 is always the same, irrespective of which light-emitting diode is lit. The mirrors 50 may, for example, be actuated by piezoelectric devices (not shown).

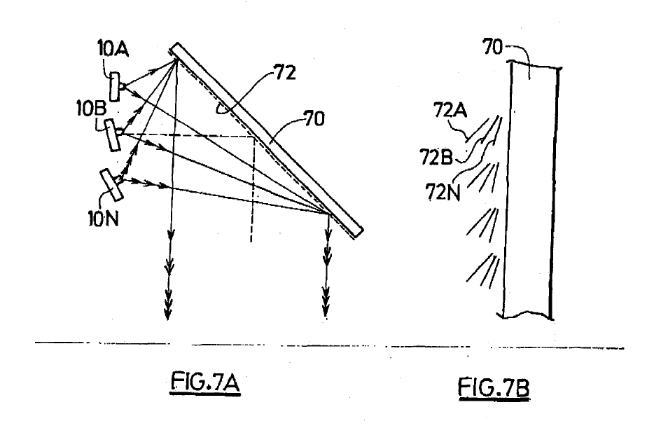

Electro-optical means could furthermore be used, as represented in FIGS. 6A and 6B, with optical switching cells 60 being arranged in the path of the light beam between the light-emitting diodes 10A, 10B, . . . 10N and the optical system 20, so that the light beam at the input of the optical system 20 is always the same, irrespective of which light-emitting diode 10A, 10B, . . . 10N is lit.

Micromirrors of the type used for video signal projection could also be used, as represented in FIGS. 7A and 7B. Such micromirrors 72 have microscopic dimensions and are arranged in a large number on a substrate 70, and they can be oriented in a predetermined direction by applying suitable electronic signals, as shown schematically in FIG. 7B. This Figure shows that the micromirrors 72 can be oriented into positions 72A, 72B, . . . 72N, as a function of the light-emitting diode 10A, 10B, . . . 10N which is lit, so that the light beam at the input of the optical system 20 is always the same, irrespective of which light-emitting diode 10A, 10B, . . . 10N is lit.

The present invention does therefore indeed provide a device for illumination or signaling that uses a plurality of light sources consisting of light-emitting diodes, whose luminance is temporarily increased without increasing the intensity of the supply current of each light-emitting diode, in order to form a light beam having an average luminance higher than that which would be obtained by using light-emitting diodes operating in steady state.

Of course, the present invention is not limited to the embodiments which have been described, and the person skilled in the art could, on the contrary, subject it to numerous modifications which fall within its scope. For instance, the number of light-emitting diodes could be any number greater than two, for example a large number of light-emitting diodes.

What is claimed is:

1. A device for illumination or signaling, comprising at least two light-emitting diodes that each emit a light beam and are supplied with a pulsed current so as to be lit alternately, the pulses of the supply current of the light-emitting diodes having an instantaneous intensity higher than the maximum intensity in steady state and an average intensity lower than this maximum value, the pulses of the supply current of the light-emitting diodes having a duty ratio greater than or equal to the inverse of the number of light-emitting diodes, which device comprises an optical system that receives the light beams emitted by the light-emitting diodes and delivers a single emergent beam, irrespective of which light-emitting diode is providing it with an incident beam.

2. The device as claimed in claim 1, wherein the light-emitting diodes are arranged on a mobile support which can be displaced in front of the optical system, the light-emitting diodes being lit synchronously with their entry into a predetermined position with respect to the optical system.

3. The device as claimed in claim 2, wherein the mobile support is a wheel or a drum.

4. The device as claimed in claim 1, wherein the light beams emitted by the various light-emitting diodes are switched so that the beam incident on the optical system is always the same, irrespective of which light-emitting diode is lit.

5. The device as claimed in claim 4, wherein the light beams emitted by the various light-emitting diodes are switched by mechanical means synchronized with the lighting and extinguishing of the light-emitting diodes.

6. The device as claimed in claim 5, wherein the mechanical means are mobile mirrors.

7. The device as claimed in claim 4, wherein the light beams emitted by the various light-emitting diodes are switched by electro-optical means synchronized with the lighting and extinguishing of the light-emitting diodes.

8. The device as claimed in claim 7, wherein the electro-optical means consist of electro-optical cells.

9. The device as claimed in claim 7, wherein the electro-optical means consist of micromirrors.
